(19) United States
(12) Patent Application Publication
(10) Pub. No.: US 2025/0040669 A1
(43) Pub. Date: Feb. 6, 2025

(54) ELECTRONIC DEVICE USING STRAP, AND FASTENING DEVICE OF STRAP

(71) Applicant: SAMSUNG ELECTRONICS CO., LTD., Suwon-si (KR)

(72) Inventor: Donggyu OH, Suwon-si (KR)

(21) Appl. No.: 18/924,863

(22) Filed: Oct. 23, 2024

Related U.S. Application Data
(63) Continuation of application No. PCT/KR2023/005176, filed on Apr. 17, 2023.

(30) Foreign Application Priority Data
Jun. 14, 2022 (KR) 10-2022-0072301
Aug. 17, 2022 (KR) 10-2022-0102791

(51) Int. Cl. A44C 5/14

(52) U.S. Cl. CPC A44C 5/14

(57) ABSTRACT

An embodiment in the present disclosure relates to a fastening structure capable of attaching/detaching a strap for an electronic device using the strap. To this end, the electronic device can have fastening grooves formed to face each other on the inner side surfaces of the pair of lugs arranged in a housing, the fastening grooves connecting an open-ended portion and a close-ended portion so as to have at least one curve. When the strap is attached/detached to/from the pair of lugs, a fastening pin can be formed in the vicinity of one end of the strap so as to move according to the fastening grooves. One end portion of the strap having the fastening pin can correspond to an end oriented toward the housing during attachment to the housing from among two ends provided at each side of the strap. Other various embodiments are possible.

### CROSS-REFERENCE TO RELATED APPLICATIONS

This application is a continuation application, claiming priority under § 365(c), of International Application No. PCT/KR2023/005176 filed on Apr. 17, 2023, which is based on and claims the benefit of Korean patent application number 10-2022-0102791 filed on Aug. 17, 2022 in the Korean Intellectual Property Office and of Korean patent application number 10-2022-0072301 filed on Jun. 14, 2022, in the Korean Intellectual Property Office, the disclosures of which are incorporated by reference herein in their entireties.

### BACKGROUND

Various embodiments of the disclosure relate to a fastening structure capable of attaching/detaching a strap in an electronic device using the strap.

In general, an electronic device may refer to a device that performs a specific function according to a program. The electronic device may include electronic schedulers, portable multimedia players, mobile communication terminals, tablet PCs, audio/video devices, desktop/laptop computers, or vehicle navigation systems. In recent years, as the integration of electronic devices increases and wireless communication is commonplace, various functions may be equipped in mobile communication terminals, such as smartphones. For example, a mobile communication terminal packs various features for entertainment, e.g., playing video games, multimedia, e.g., playing music/video, security for mobile banking, or as a scheduler or e-wallet, as well as communication capabilities.

As electronic and communication technology advances, electronic devices are becoming smaller to be conveniently carried and worn by users. Electronic devices have become so small or lightweight that users may use them without any discomfort, even when worn on the body. For example, in addition to mobile communication devices, such as smartphones, users are increasingly using wearable devices, such as wireless earphones or smartwatches that may be connected to smartphones.

Wearable devices are being developed with the goal of increasing portability and diversifying functions. For convenience of portability, there may be assistant devices that assist in carrying or wearing the wearable device. For example, in relation to a watch-type wearable device, there may be a strap to assist wearing.

The strap that assists in wearing the wearable device may be replaced by the user as needed. For this purpose, the strap needs to have a fastening structure to be mounted on the main body of the wearable device or easy to attach and detach.

### SUMMARY

An embodiment of the disclosure may provide a fastening structure for attaching/detaching the strap to/from the housing by forming a fastening groove in the lugs of the housing to guide the movement of the fastening pin provided in the strap in the electronic device.

According to an embodiment, an electronic device may include a housing having a pair of lugs, whose inner surfaces face each other, provided on two opposite sides to be substantially symmetrical. The electronic device may include a strap configured to be fitted to the pair of lugs provided in the housing to be mounted or detachable. A fastening groove connecting an open end and a closed end to have at least one bend may be formed to face the inner surfaces of each of the pair of lugs. In the electronic device, a fastening pin may be provided near one end of the strap to move along the fastening groove when the strap is mounted to or detached from the pair of lugs. Here, one end portion of the strap provided with the fastening pin may correspond to an end facing the housing when mounted to the housing, of two opposite ends provided in the strap.

According to an embodiment of the disclosure, in the electronic device, the strap may be attached or detached to/from the housing by moving the strap along the fastening groove provided in the lugs of the housing, making strap attachment/detachment easy.

An embodiment of the disclosure may provide a fastening structure for attaching/detaching a strap mounted to lugs of a housing in an electronic device by a pressure applied from the outside.

According to an embodiment, in a fastening device fastening a strap in an electronic device, a fastening groove may be formed in inner surfaces of lugs provided to face each other on two opposite sides of a housing to connect an open end and a closed end to have at least one bend. In the fastening device, a fastening pin or a pressing portion may be provided near a first end of the strap to move along the fastening groove when the strap is mounted to or detached from the lugs. Here, the first end of the strap provided with the pressing portion or the fastening pin may correspond to an end facing the housing when mounted to the housing, of two opposite ends provided in the strap.

According to an embodiment of the disclosure, as the pressing portion is provided to be able to detach the strap from the housing in the electronic device by a physical external force, the user may more conveniently detach the strap from the housing.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

FIG. 1 is a view illustrating an electronic device in a network environment according to various embodiments;

FIG. 2A is a front perspective view illustrating an electronic device according to an embodiment;

FIG. 2B is a rear perspective view illustrating an electronic device according to an embodiment;

FIG. 2C is a disassembled perspective view illustrating an electronic device according to an embodiment;

FIG. 3 is a perspective view illustrating a strap in an electronic device according to an embodiment;

FIG. 4A is a perspective view illustrating the fastening pin illustrated in FIG. 3;

FIG. 4B is a disassembled perspective view illustrating the fastening pin illustrated in FIG. 4A;

FIG. 5 is a plan view illustrating a housing in an electronic device according to an embodiment;

FIG. 6 is a cross-sectional view taken along line A-A of FIG. 5;

FIG. 7 is a cross-sectional view taken along line B-B of FIG. 5;

FIG. 8 is a cross-sectional view taken along line C-C of FIG. 6;

FIG. 9 is a see-through view illustrating that a strap is mounted to a lug of a housing in an electronic device according to an embodiment;

FIG. 10 is a plan view illustrating that a strap is mounted to a lug of a housing in an electronic device according to an embodiment;

FIG. 11 is a cross-sectional view taken along line D-D of FIG. 10;

FIG. 12 is a view illustrating an operation of detaching a strap from a lug of a housing in an electronic device according to an embodiment;

FIG. 13 is a cross-sectional view taken along line A-A of FIG. 5;

FIG. 14 is a cross-sectional view taken along line E-E of FIG. 13;

FIG. 15 is a partial cross-sectional view illustrating that a strap is mounted to a lug of a housing in an electronic device according to an embodiment;

FIG. 16 is a cross-sectional view taken along line C-C of FIG. 6; and

FIG. 17 is a see-through view illustrating that a strap is mounted to a lug of a housing in an electronic device according to an embodiment.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

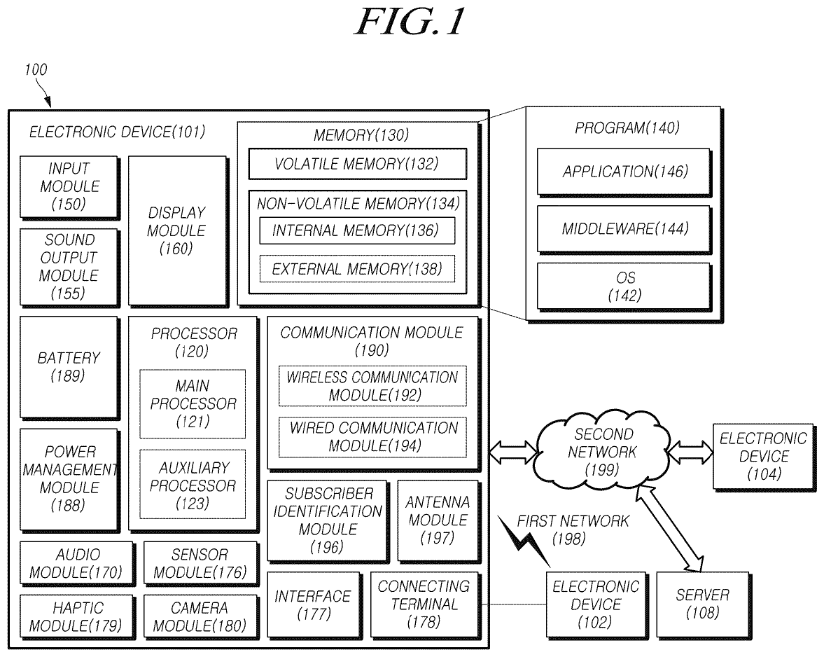

FIG. 1 is a block diagram illustrating an electronic device 101 in a network environment 100 according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

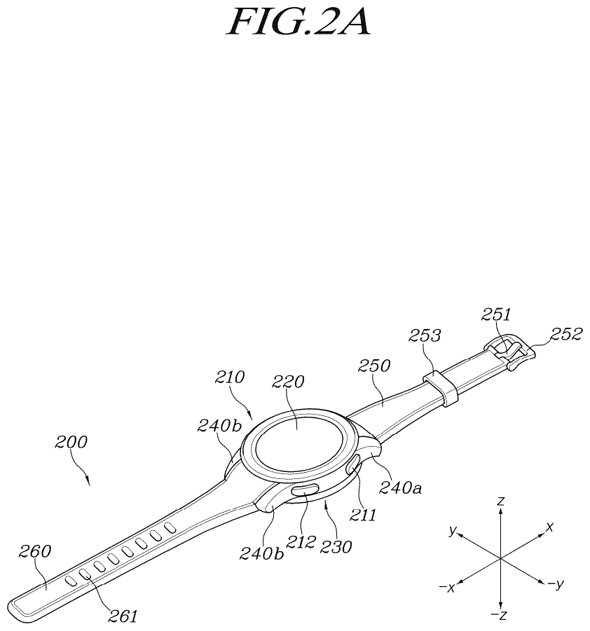

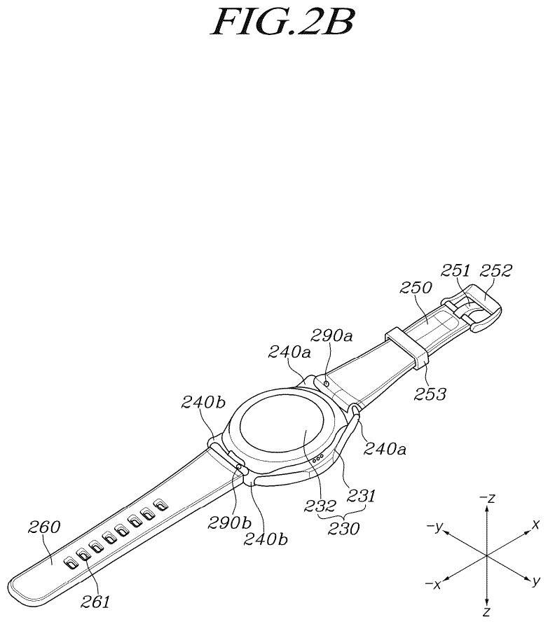

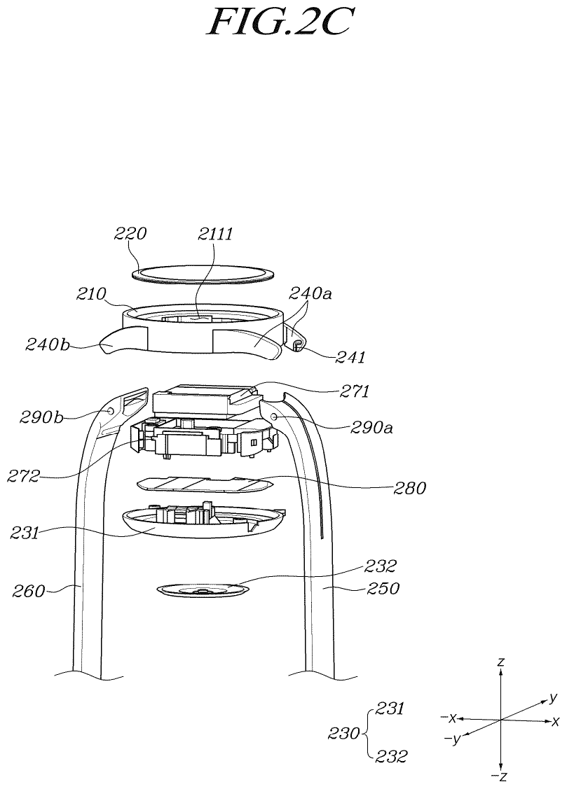

FIG. 2A is a front perspective view illustrating an electronic device (e.g., the electronic device 101 of FIG. 1) according to an embodiment.

FIG. 2B is a rear perspective view illustrating an electronic device (e.g., the electronic device 101 of FIG. 1) according to an embodiment.

FIG. 2C is a disassembled perspective view illustrating an electronic device (e.g., the electronic device 101 of FIG. 1) according to an embodiment.

Referring to FIGS. 2A to 2C, the electronic device 200 according to an embodiment may be a wearable electronic device that the user may wear while carrying. In an embodiment, the electronic device 200 may be a smart watch that displays information such as time, weather, battery, or notification.

According to an embodiment, the electronic device 200 may include a housing 210, a display 220 (e.g., the display module 160 of FIG. 1), a back cover 230, lugs 240a and 240b, straps 250 and 260, a battery 271 (e.g., the battery 189 of FIG. 1), a support member 272, or a printed circuit board (PCB) 280.

According to an embodiment, the housing 210 may form the appearance of the electronic device 200. In an embodiment, the housing 210 may form an upper/side appearance of the electronic device 200. In an embodiment, the housing 210 may have an annular shape as a whole, but is not limited thereto. In an embodiment, the housing 210 may include an opening 2111 configured to penetrate the upper/lower surface of the housing 210. In an embodiment, the lugs 240a and 240b may be integrally provided with the housing 210.

According to an embodiment, side buttons 211 and 212 may be disposed on one side surface of the housing 210. The side buttons 211 and 212 may be configured to receive, e.g., a command regarding an operation of an application being executed by the user's manipulation.

According to an embodiment, the display 220 may be coupled to a front surface (e.g., an uppermost surface) of the housing 210. In an embodiment, at least a portion of the display 220 may be visually exposed to the outside while covering the opening 2111 of the housing 210. The display 220 may output, e.g., information about an operation of an application being executed. The display 220 may be coupled to or disposed adjacent to a touch sensing circuit (not shown), a pressure sensor (not shown) capable of measuring the intensity (pressure) of a touch, and/or a fingerprint sensor (not shown).

According to an embodiment, the back cover 230 may form a lower appearance of the electronic device 200. In an embodiment, the back cover 230 may be coupled to the lower side of the housing 210. In an embodiment, the back cover 230 may include a back plate 231 or a glass portion 232. According to an embodiment, the back plate 231 may be formed of an opaque material. According to an embodiment, the glass portion 232 may be formed of a transparent material. In an embodiment, the sensor module (e.g., the sensor module 176 of FIG. 1) may easily detect a sensor signal such as the user's biometric signal through the glass portion 232. According to an embodiment, the glass portion 232 may be provided as a separate member from the back plate 231 to be coupled to the back plate 231, but is not limited thereto and may be provided integrally with the back plate 231.

According to an embodiment, the lugs 240a and 240b may include a first lug 240a or a second lug 240b. In an embodiment, a pair of first lugs 240a may be provided. In an embodiment, each of the pair of first lugs 240a may protrude from the outer circumferential surface of the housing 210 toward one side (e.g., the x direction). In an embodiment, the first lug 240a and the second lug 240b may be disposed or formed to be substantially symmetrical on two opposite sides of the housing 210. According to an embodiment, a pair of the second lugs 240b may be provided. According to an embodiment, each of the pair of second lugs 240b may protrude from the outer circumferential surface of the housing 210 toward the other side (e.g., the −x direction). In an embodiment, the pair of second lugs 240b may be disposed so that the inner surfaces thereof face each other.

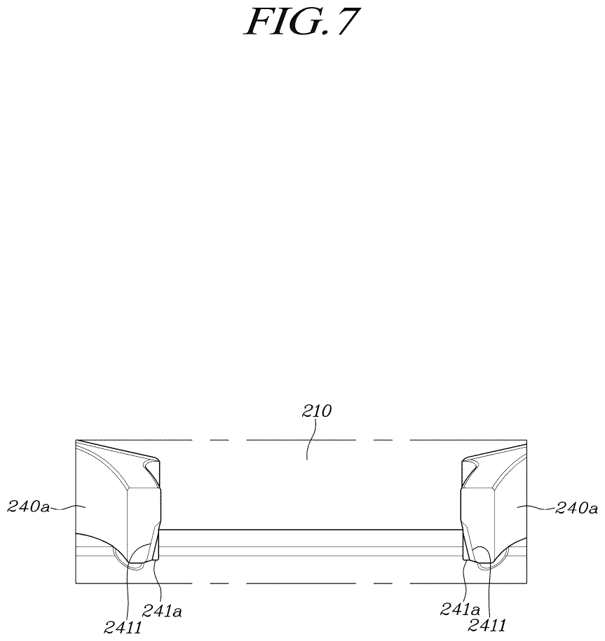

According to an embodiment, a fastening groove 241 for fastening with the strap 250 and 260 may be provided on one side surface (e.g., an inner surface) of each of the pair of lugs 240a and 240b. The structure and/or shape of the fastening groove 241 is described below with reference to FIGS. 7 to 11.

According to an embodiment, the straps 250 and 260 may be detachably coupled to the lugs 240a and 240b. In an embodiment, in a state in which the straps 250 and 260 are coupled to the lugs 240a and 240b, one end of the straps 250 and 260 may be disposed to be inserted between the pair of lugs 240a and 240b. As one end of the strap 250 and 260 is disposed to be in contact with one side surface of the housing 210, the movement of the straps 250 and 260 with respect to the lugs 240a and 240b may be restricted.

According to an embodiment, the straps 250 and 260 may include a first strap 250 or a second strap 260. In an embodiment, the first strap 250 may be coupled to the pair of first lugs 240a on one side (e.g., the x direction) of the housing 210. In an embodiment, the second strap 260 may be coupled to the pair of second lugs 240b on the other side (e.g., in the −x direction) of the housing 210.

According to an embodiment, the first fastening pin 290a provided at one end of the first strap 250 may be inserted into the first fastening groove 241 of the pair of first lugs 240a. As the first fastening pin 290a is inserted into the first fastening groove 241, the first strap 250 may be coupled to the pair of first lugs 240a. In an embodiment, the first strap 250 may be separated from the pair of first lugs 240a as the first fastening pin 290a provided at one end thereof is removed from the first fastening grooves 241 of the pair of first lugs 240a.

According to an embodiment, the second fastening pin 290b provided at one end of the second strap 260 may be inserted into the second fastening grooves (not shown) of the pair of second lugs 240b. As the second fastening pin 290b is inserted into the second fastening groove (not shown), the second strap 260 may be coupled to the pair of second lugs 240b. In an embodiment, the second strap 260 may be separated from the pair of second lugs 240b as the second fastening pin 290b provided at one end is removed from the second fastening grooves (not shown) of the pair of second lugs 240b.

According to an embodiment, the first strap 250 may include a fixing member 251, a strap guide member 252, or a strap fixing ring 253.

According to an embodiment, the second strap 260 may include at least one fastening hole 261 into which the fixing member 251 is inserted.

According to an embodiment, the fixing member 251 may be configured to fix the housing 210 or the strap 250 and 260 to a body part (e.g., a wrist or an ankle) of the user. In an embodiment, when a plurality of fastening holes 261 are provided, the fixing member 251 may be provided to be inserted into one of the plurality of fastening holes 261. For example, the plurality of fastening holes 261 may enable fastening between straps 250 and 260 corresponding to the circumference of the user's body (e.g., the circumference of the wrist or the circumference of the ankle).

According to an embodiment, the strap guide member 252 may be configured to limit the movement range of the fixing member 251 when the fixing member 251 is inserted into the fastening hole 261. The fixing member 251 may allow the straps 250 and 260 to be fastened in tight contact to a part of the user's body.

According to an embodiment, the band fixing ring 253 may limit the movement range of the straps 250 and 260 in a state in which the fixing member 251 is inserted into the fastening hole 261.

According to an embodiment, the display 220 may be coupled to one surface (e.g., z direction) of the support member 272. The printed circuit board 280 may be coupled to the other surface (e.g., in the −z direction) of the support member 272. As an embodiment, a mounting recess (not shown) may be formed in one surface (e.g., in the z direction) of the support member 272. The battery 271 may be mounted in the mounting recess formed in one surface of the support member 272.

According to an embodiment, components for operating the electronic device 200 may be disposed on the printed circuit board 280. For example, at least one of a processor (e.g., the processor 120 of FIG. 1), a memory (e.g., the memory 130 of FIG. 1), and an interface (e.g., the interface 177 of FIG. 1) may be disposed on the printed circuit board 280.

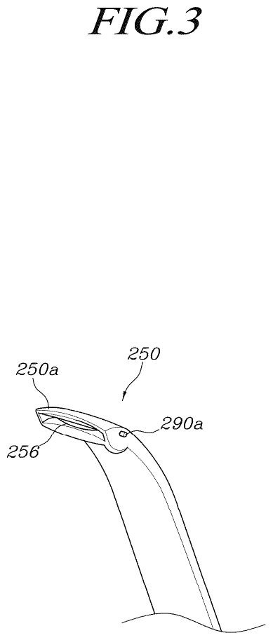

FIG. 3 is a perspective view illustrating a portion of a strap (e.g., the first strap 250 of FIG. 2A) in an electronic device (e.g., the electronic device 200 of FIG. 2A) according to an embodiment.

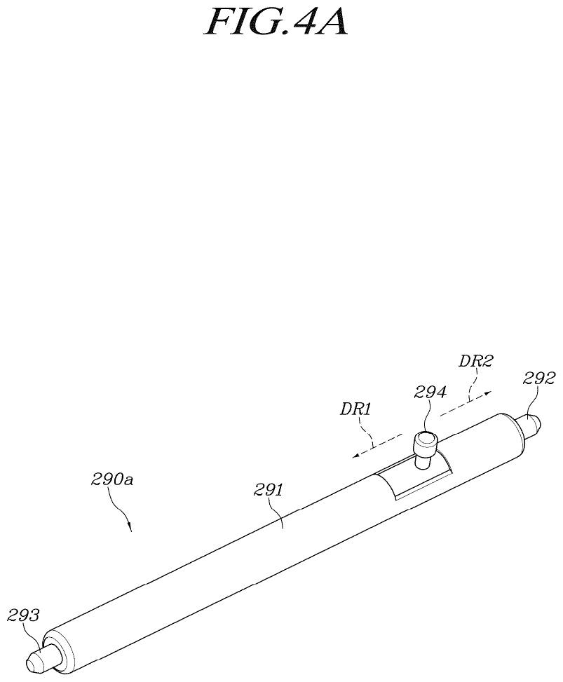

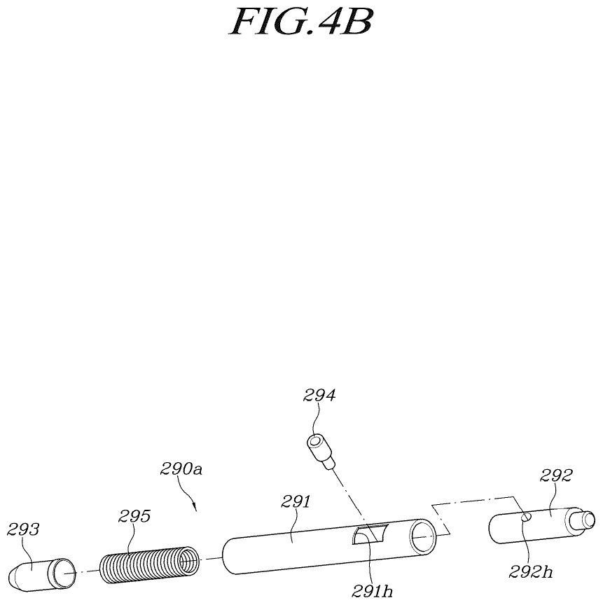

FIG. 4A is a perspective view illustrating one of the fastening pins (e.g., the fastening pin 290a and 290b of FIG. 2B) illustrated in FIG. 3.

FIG. 4B is a disassembled perspective view illustrating the fastening pin (e.g., the fastening pin 290a and 290b of FIG. 2B) illustrated in FIG. 4A.

Although only one strap (e.g., the first strap 250 of FIG. 2A) is illustrated in FIG. 3, at least one configuration of the second strap (e.g., the second strap 260 of FIG. 2A) may correspond to the first strap 250 in terms of operation, structure, or shape. For example, the second strap 260 may include a second pressing portion (not shown) and a second fastening pin (e.g., the second fastening pin 290b of FIG. 2B). Each of the second pressing portion of the second strap 260 and the second fastening pin 290b may have a structure corresponding to the first pressing portion 256 of the first strap 250 or the first fastening pin (e.g., the first fastening pin 290a of FIG. 2B). In this case, the description of the first pressing portion 256 or the first fastening pin 290a may be equally applied to the second pressing portion or the second fastening pin 290b.

Referring to FIGS. 3 to 4B, in an embodiment, the first strap 250 may include a first pressing portion 256 or a first fastening pin 290a.

According to an embodiment, the first pressing portion 256 may be disposed at one end 250a of the first strap 250. In an embodiment, the first pressing portion 256 may be formed to be open toward the housing (e.g., the housing 210 of FIG. 2A). In an embodiment, the first pressing portion 256 may be formed by being recessed from one end 250a of the first strap 250. In an embodiment, the first pressing portion 256 may correspond to at least a portion of the first strap 250 to which the user applies pressure. For example, when the user presses the upper portion of the first strap 250, at least a portion of the first strap 250 (e.g., the upper portion of the first strap 250) may be deformed (or bent) toward the first pressing portion 256 by the pressing.

According to an embodiment, the first fastening pin 290a may be coupled to one end 250a of the first strap 250. In an embodiment, the first fastening pin 290a may be configured to pass through one end 250a of the first strap 250. In an embodiment, the first fastening pin 290a may be inserted into first fastening grooves (e.g., the first fastening grooves 241 of FIG. 2C) provided in a pair of first lugs (e.g., the pair of first lugs 240a of FIG. 2C). In an embodiment, when an external force (e.g., an operation of the user) is applied to the first strap 250, the first fastening pin 290a may move along a path provided by the first fastening groove 241. For example, corresponding to the direction of the external force applied to the first strap 250, the first fastening pin 290a may be seated on the end of the first fastening groove 241 so that the first strap 250 is coupled (or mounted) to the pair of first lugs 240a, or may be separated from the start end of the first fastening groove 241 of the first fastening pin 290a so that the first strap 250 is removed (or detached) from the pair of first lugs 240a.

According to an embodiment, the first fastening pin 290a may include a pin body 291, a first pin 292, a second pin 293, a pin handle 294, or a pin spring 295.

According to an embodiment, the pin body 291 may form the appearance of the first fastening pin 290a. In an embodiment, the fin body 291 may be configured to have a substantially cylindrical shape.

According to an embodiment, a fastening hole 291h may be disposed in the outer circumferential surface of the fin body 291. In an embodiment, the fastening hole 291h may be formed to be open along the length direction (e.g., the first direction DR1 or the second direction DR2) of the pin body 291.

According to an embodiment, at least a portion of the first pin 292 may be accommodated in the pin body 291. In an embodiment, at least a portion of the first pin 292 may be inserted into the pin body 291 from one side. In an embodiment, a fitting hole 292h may be disposed in the outer circumferential surface of the first pin 292. In an embodiment, the fitting hole 292h may be formed as an opening in the outer circumferential surface of the first pin 292 to have a shape corresponding to the pin handle 294.

According to an embodiment, at least a portion of the second pin 293 may be accommodated in the pin body 291. In an embodiment, at least a portion of the second pin 293 may be inserted into the pin body 291 from the other side.

According to an embodiment, the pin handle 294 may be inserted into the fitting hole 292h to be coupled to the first pin 292. In an embodiment, the pin handle 294 may move the first pin 292 so that the area of the first pin 292 exposed to the outside from the pin body 291 increases or decreases. For example, when an external force (e.g., an operation of the user) is applied to the pin handle 294, the pin handle 294 may move in the first direction DR1 or the second direction DR2 along the fastening hole 291h corresponding to the direction in which the external force is applied. For example, the pin handle 294 may move the first pin 292 connected to the pin handle 294 in the first direction DR1 or the second direction DR2 within a limited range formed by the fastening hole 291h.

According to an embodiment, the pin spring 295 may be accommodated in the pin body 291. In an embodiment, the pin spring 295 may be disposed between the first pin 292 and the second pin 293. In an embodiment, one end of the pin spring 295 may contact the first pin 292 and the other end of the pin spring 295 may contact the second pin 293. For example, as the pin spring 295 is compressed/extended corresponding to the direction of the external force applied to the pin handle 294, the pin spring 295 may provide an elastic force (or restoring force) to the first pin 292 or the second pin 293.

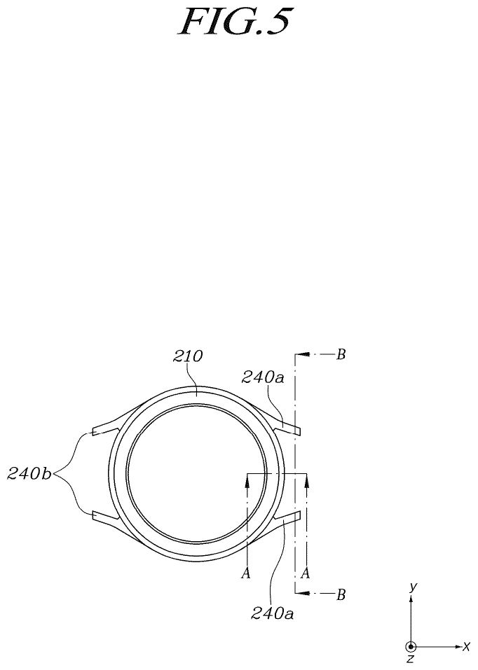

FIG. 5 is a plan view illustrating a housing (e.g., the housing 210 of FIG. 2A) in an electronic device (e.g., the electronic device 200 of FIG. 2A) according to an embodiment.

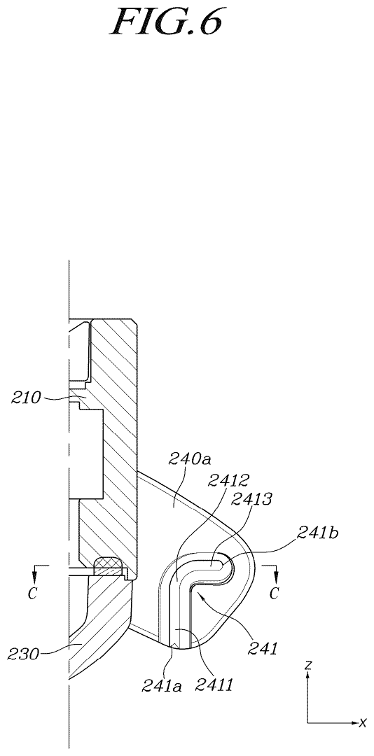

FIG. 6 is a cross-sectional view taken along line A-A of FIG. 5.

FIG. 7 is a cross-sectional view taken along line B-B of FIG. 5.

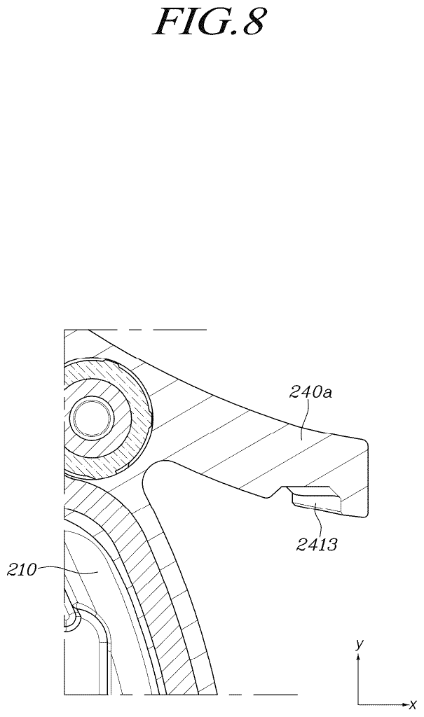

FIG. 8 is a cross-sectional view taken along line C-C of FIG. 6.

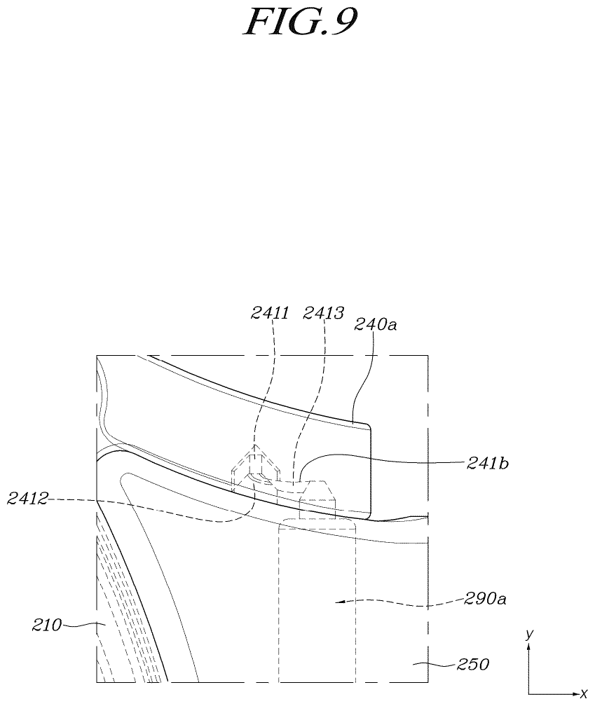

FIG. 9 is a see-through view illustrating a strap (e.g., the straps 250 and 260 of FIG. 2A) is mounted to a lug (e.g., the lugs 240a and 240b of FIG. 2A) of a housing (e.g., the housing 510 of FIG. 2A) in an electronic device (e.g., the electronic device 200 of FIG. 2A) according to an embodiment.

Although FIGS. 6 to 9 illustrate only a pair of first lugs (e.g., the pair of first lugs 240a of FIG. 2A), the pair of second lugs (e.g., the pair of second lugs 240b of FIG. 2A) may be symmetrical to the pair of first lugs 240a in terms of operation, structure, or shape. For example, second fastening grooves (not shown) may be formed in the pair of second lugs 240b. The description of the first fastening groove 241 may be equally applied to the second fastening groove.

Referring to FIGS. 5 to 9, in an embodiment, a first fastening groove 241 may be disposed in one side surface of the pair of first lugs 240a. In an embodiment, the first fastening groove 241 may be formed by being recessed from one side surface of the pair of first lugs 240a. Here, the one side surface of the pair of first lugs 240a may refer to a surface facing the first strap 250 in a state in which the pair of first lugs 240a and the first strap (e.g., the first strap 250 of FIG. 2C) are coupled. In an embodiment, the first fastening groove 241 may provide a path through which a first fastening pin (e.g., the first fastening pin 290a of FIG. 2C) is inserted into the first fastening groove 241 to move when the first strap 250 is attached/detached.

According to an embodiment, the first fastening groove 241 may include a first guide groove 2411, a connecting groove 2412, or a second guide groove 2413.

According to an embodiment, the connecting groove 2412 may be formed to have at least one bend. For example, the connecting groove 2412 may include a bent portion connecting the first guide groove 2411 and the second guide groove 2413. In one embodiment, the angle of the bent portion (e.g., bend) of the connecting groove 2412 connecting the first guide groove 2411 and the second guide groove 2413 may be 60 degrees to 120 degrees.

According to an embodiment, the start end 241a (or an open end) of the first fastening groove 241 may form an opening in the rear side (e.g., in the −z direction) of the pair of first lugs 240a. In an embodiment, the first fastening pin 290a may be inserted into the start end 241a of the first fastening groove 241. The first fastening pin 290a may move along the first guide groove 2411, the connecting groove 2412, or the second guide groove 2413.

According to an embodiment, the first guide groove 2411 may be connected to the start end 241a of the first fastening groove 241. In an embodiment, the first guide groove 2411 may extend in a vertical direction (or a first direction) (e.g., a z direction) from the start end 241a of the first fastening groove 241. In an embodiment, the first guide groove 2411 may form a first straight section that is a path along which the first fastening pin 290a inserted into the first fastening groove 241 moves. In an embodiment, the first guide groove 2411 may be recessed from one side surface of the pair of first lugs 240a so that the depth of the groove gradually decreases toward the connecting groove 2412. For example, in order to insert the first fastening pin 290a into the first fastening groove 241, an external force required for the first fastening pin 290a increases, and the first fastening pin 290a is pressed.

According to an embodiment, one end of the connecting groove 2412 may be connected to the first guide groove 2411. The other end of the connecting groove 2412 may be connected to the second guide groove 2413. In an embodiment, the connecting groove 2412 may form a curved section that is a path along which the first fastening pin 290a inserted into the first fastening groove 241 moves.

According to an embodiment, the second guide groove 2413 may extend in a horizonal direction (or a second direction) (e.g., an x direction) from the connecting groove 2412. Here, the second direction may mean a direction perpendicular to, or crossing, the first direction. In an embodiment, the second guide groove 2413 may form a second straight section that is a path along which the first fastening pin 290a inserted into the first fastening groove 241 moves. In an embodiment, the second guide groove 2413 may be recessed from one side surface of the pair of first lugs 240a so that the depth of the groove gradually increases toward the second direction. In an embodiment, the second guide groove 2413 may be recessed from one side surface of the pair of first lugs 240a so that the recess surface is formed in parallel with the second direction (e.g., the x direction).

According to an embodiment, the end 241b (or a closed end) of the first fastening groove 241 may be closed by one side surface of the pair of first lugs 240a. For example, the end 241b of the first fastening groove 241 may mean the end point of the moving path of the first fastening pin 290a formed by the first fastening groove 241 (or the second guide groove 2413). The first fastening pin 290a inserted into the start end 241a of the first fastening groove 241 may reach the end 241b of the first fastening groove 241 through, e.g., the first guide groove 2411, the connecting groove 2412, or the second guide groove 2413. When the first fastening pin 290a reaches the end of the first fastening groove 241, coupling between the pair of first lugs 240a and the first strap 250 may be completed.

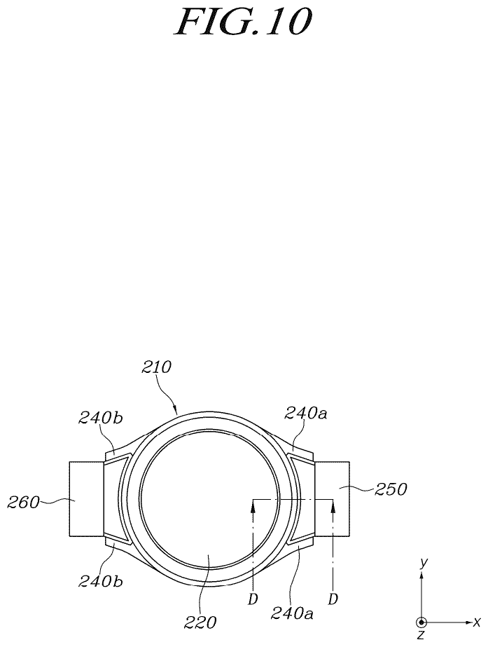

FIG. 10 is a plan view illustrating a housing (e.g., the housing 210 of FIG. 2A) in an electronic device (e.g., the electronic device 200 of FIG. 2A) according to an embodiment.

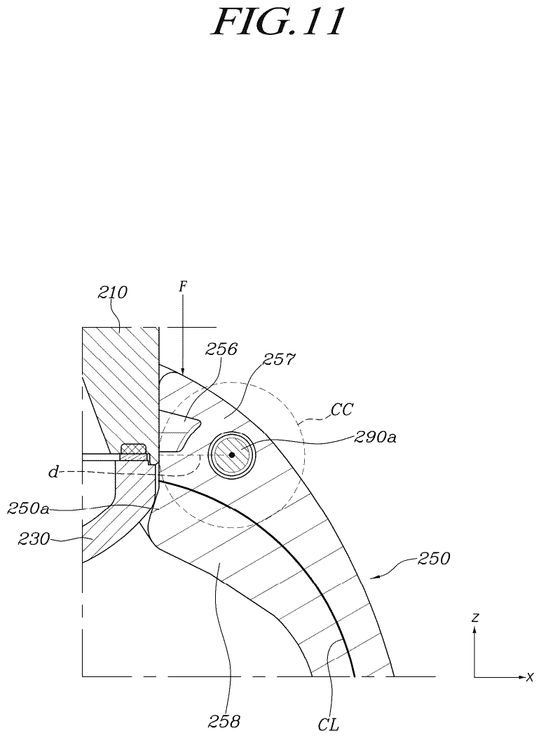

FIG. 11 is a cross-sectional view taken along line D-D of FIG. 10.

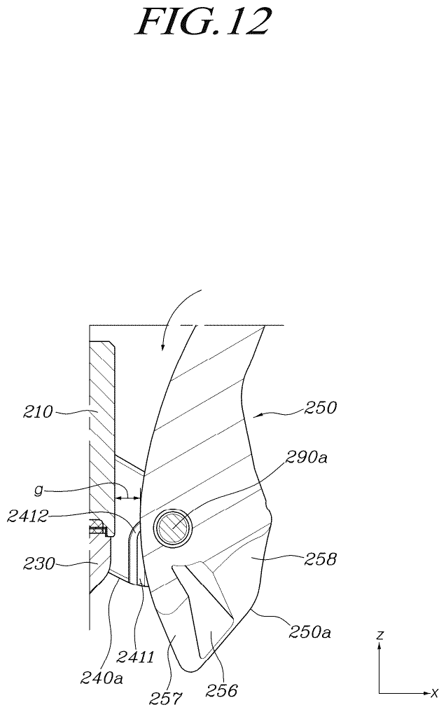

FIG. 12 is a view illustrating an operation of attaching/detaching a strap (e.g., the straps 250 and 260 of FIG. 2A) from a lug (e.g., the lugs 240a and 240b of FIG. 2A) of a housing (e.g., the housing 210 of FIG. 2A) in an electronic device (e.g., the electronic device 200 of FIG. 2A) according to an embodiment.

Although only the first strap 250 (e.g., the first strap 250 of FIG. 2A) is illustrated in FIGS. 11 and 12, the first strap 250 and the second strap 260 may have structures corresponding to each other in terms of operation, structure, and shape. In this case, the description of the first strap 250 may be equally applied to the second strap (e.g., the second strap 260 of FIG. 2A).

Referring to FIG. 10, in a state in which the straps 250 and 260 are coupled to the pair of lugs 240a and 240b, one end of the straps 250 and 260 may contact one side surface of the housing 210.

Referring to FIG. 11, in an embodiment, the first strap 250 may be divided into an upper portion 257 and a lower portion 258 with respect to a virtual center line CL passing through the center of the first strap 250. For example, the upper portion 257 may be positioned on one side (e.g., z direction) of the center line CL. The lower portion 258 may be positioned on the other side (e.g., in the −z direction) of the center line CL.

According to an embodiment, the first pressing portion 256 may be disposed on the upper portion 257 of the first strap 250, but is not limited thereto. According to an embodiment, the first pressing portion 256 may be disposed in the upper portion 257 or the lower portion 258 of the first strap 250. In an embodiment, the pressing portion 256 may be disposed closer to the upper portion 257 (or the upper surface of the first strap 250) than the lower portion 258 (or the rear surface of the first strap 250) with respect to the center line CL. In an embodiment, the thickness of the lower portion 258 of the first strap 250 may be set to be thicker than the thickness of the upper portion 257 of the first strap 250.

According to an embodiment, the first strap 250 may be formed of a rubber material, but is not limited thereto. In an embodiment, the first strap 250 may be configured so that materials of the upper portion 257 and the lower portion 258 are different from each other with respect to the first pressing portion 256. In an embodiment, the upper portion 257 and the lower portion 258 of the first strap 250 may be configured so that the hardness of the upper portion 257 of the first strap 250 positioned above the first pressing portion 256 (e.g., in the z direction) is different from the hardness of the lower portion 258 of the first strap 250 positioned below the first pressing portion 256 (e.g., in the −z direction). For example, the hardness of the upper portion 257 of the first strap 250 may be configured to be lower than that of the lower portion 258 of the first strap 250. For example, when an external force (e.g., the user's pressing operation) is applied to the upper portion 257 of the first strap 250 corresponding to the upper side of the pressing portion 256, deformation (or bending) of the upper portion 257 of the first strap 250 toward the first pressing portion 256 may be easy.

It may be identified that the upper portion 257 or the lower portion 258 of the first strap 250 is positioned outside the radius of the circle CC with respect to the virtual circle CC having the distance d from the first fastening pin 290a to one side surface of the housing 210 as a radius. For example, in a state in which the pair of first lugs 240a and the first strap 250 are coupled, at least a portion of the upper portion 257 or the lower portion 258 of the first strap 250 may contact the housing 210 and thus the movement (or rotation) of the first strap 250 is limited, thereby stably maintaining the coupling of the pair of first lugs 240a and the first strap 250.

Referring to FIG. 11, when an external force F (e.g., the user's pressing operation) is applied to the upper portion 257 (or the upper surface of the upper portion 257) of the first strap 250 positioned above the first pressing portion 256, at least a portion of the upper portion 257 of the first strap 250 adjacent to the housing 210 may be deformed (or bent) toward the first pressing portion 256. In this case, the opening formed by the first pressing portion 256 may also be deformed.

Although not specifically illustrated in the drawings, if the upper portion 257 of the first strap 250 is deformed (or bent) toward the first pressing portion 256 by the external force F, at least a portion of the upper portion of the first strap 250 may be positioned inside the radius of the virtual circle CC. For example, as illustrated in FIG. 12, if an external force (e.g., the user's pressing operation and the user's rotating operation) is applied to the first strap 250, the first strap 250 may be rotated so that the upper surface of the upper portion 257 of the first strap 250 faces one side surface of the housing 210. For example, if the user rotates the first strap 250 in the counterclockwise direction while pressing the upper portion 257 of the first strap 250, the upper surface of the upper portion 257 of the first strap 250 and one side surface of the housing 210 may face each other, forming a predetermined gap g between the first strap 250 and the housing 210. The gap g between the first strap 250 and the housing 210 may be set to be equal to or larger than, e.g., the extension distance of the second guide groove (e.g., the second guide groove 2413 of FIG. 6) of the first fastening groove 241.

In a state in which the rotation of the first strap 250 is completed, the first fastening pin 290a may move in the horizontal direction (e.g., the −x direction) toward the connecting groove 2412 along the second guide groove 2413 through the gap g. The first fastening pin 290a may move to the first guide groove 2411 through the connecting groove 2412, and may move in a vertical direction (e.g., −z direction) from the first guide groove 2411 to be separated from the first fastening groove 241. As a result, the first strap 250 may be separated from the pair of first lugs 240a as the first fastening pin 290a moves along the first fastening groove 241.

The user may press the upper side of the first pressing portion 256 (e.g., the upper portion 257 of the first strap 250) to rotate the first strap 250 in the counterclockwise direction, and then move the first fastening pin 290a along the first fastening groove 241 through the gap g between the housing 210 and the first strap 250 generated by the rotation of the first strap 250 to easily separate the first strap 250 from the pair of first lugs 240a.

The process of coupling the first strap 250 to the pair of first lugs 240a may correspond to the reverse order of the process of separating the first strap 250 from the pair of first lugs 240a described above. In a state in which the upper surface of the upper portion 257 of the first strap 250 faces one side surface of the housing 210, the first fastening pin 290a of the first strap 250 is inserted into the first fastening groove 241, and then the first fastening pin 290a is moved in the vertical/horizontal direction along the first fastening groove 241 so that the first fastening pin 290a is positioned at the end 241b of the first fastening groove 241. If the first fastening pin 290a reaches the end 241b of the first fastening groove 241, the first strap 250 is rotated clockwise. The upper surface of the upper portion 257 of the first strap 250 may contact one side surface of the housing 210 by the rotation of the first strap 250, and at least a portion of the upper portion 257 of the first strap 250 may be deformed toward the first pressing portion 256 by a reaction force caused by the contact with the housing 210. If the rotation of the first strap 250 is completed, the deformed portion of the upper portion 257 of the first strap 250 may be restored again, and thus the one end 250a of the first strap 250 comes in tight contact with one side surface of the housing 210, so that coupling of the first strap 250 to the pair of first lugs 240a may be completed.

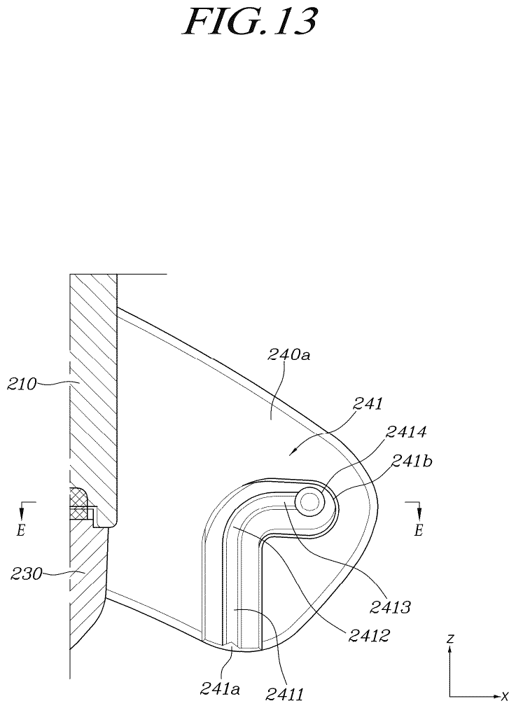

FIG. 13 is a cross-sectional view taken along line A-A of FIG. 5.

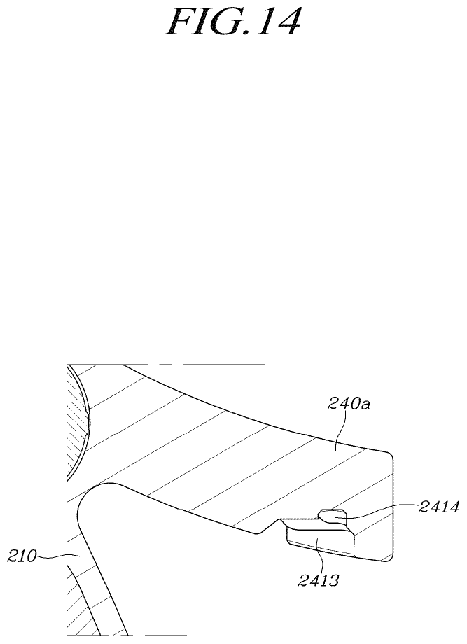

FIG. 14 is a cross-sectional view taken along line E-E of FIG. 13.

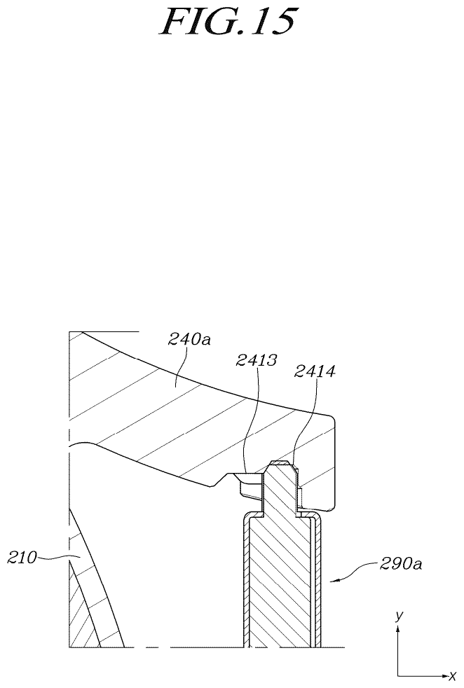

FIG. 15 is a partial cross-sectional view illustrating that a strap is mounted to a lug of a housing in an electronic device according to an embodiment.

Referring to FIGS. 13 to 15, in an embodiment, a first fastening groove (e.g., the first fastening groove 241 of FIG. 2C) may be formed in one side surface of a pair of first lugs (e.g., the pair of first lugs 240a of FIG. 2A). The first fastening groove 241 may include a first guide groove (e.g., the first guide groove 2411 of FIG. 6), a connecting groove (e.g., the connecting groove 2412 of FIG. 6), or a second guide groove (e.g., the second guide groove 2413 of FIG. 6).

According to an embodiment, a first pinhole 2414 may be disposed at an end of the second guide groove 2413. In an embodiment, the first pinhole 2414 may be recessed from the recess surface of the second guide groove 2413 so that the depth of the groove is deeper than the depth of the second guide groove 2413.

According to an embodiment, a first pin (e.g., the first pin 292 of FIG. 4A) or a second pin (e.g., the second pin 293 of FIG. 4A) of a first fastening pin (e.g., the first fastening pin 290a of FIG. 2B) moving along the second guide groove 2413 may be inserted into the first pin hole 2414. In an embodiment, the first pinhole 2414 may be configured to have a shape corresponding to the first pin 292 or the second pin 293 of the first fastening pin 290a.

If the first fastening pin 290a moves along the first fastening groove 241 and reaches the first pinhole 2414, the first pin 292 or the second pin 293 of the first fastening pin 290a may be inserted into the first pinhole 2414 to indirectly inform the user that the coupling of the first strap 250 is completed.

If the first fastening pin 290a is seated in the first pinhole 2414, the movement of the first fastening pin 290a toward the second guide groove 2413 is limited due to the depth difference of the groove between the first pinhole 2414 and the second guide groove 2413. Therefore, even when the first strap 250 does not contact one side surface of the housing 210, easy separation of the first strap 250 from the pair of first lugs 240a may be reduced unless a separate external force is applied to the first strap 250.

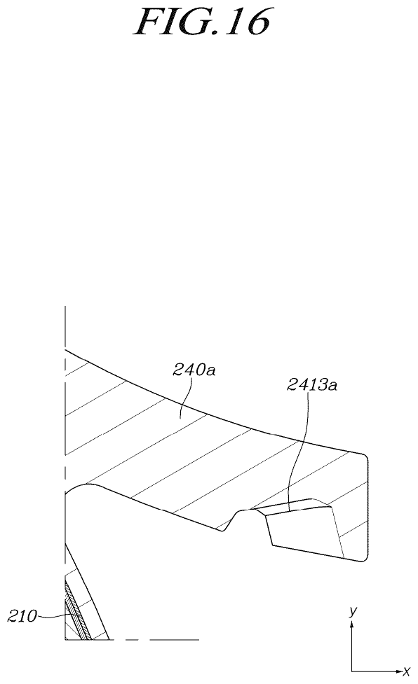

FIG. 16 is a cross-sectional view taken along line C-C of FIG. 6.

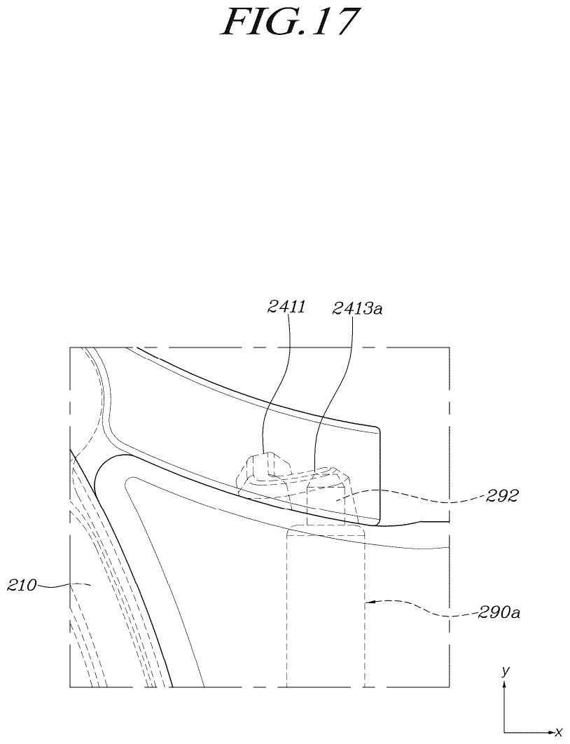

FIG. 17 is a see-through view illustrating a strap (e.g., the straps 250 and 260 of FIG. 2A) is mounted to a lug (e.g., the lugs 240a and 240b of FIG. 2A) of a housing (e.g., the housing 210 of FIG. 2A) in an electronic device (e.g., the electronic device 200 of FIG. 2A) according to an embodiment.

Referring to FIGS. 16 and 17, in an embodiment, a first fastening groove (e.g., the first fastening groove 241 of FIG. 2C) may be formed in one side surface of a pair of first lugs (e.g., the pair of first lugs 240a of FIG. 2A).

The first fastening groove 241 may include a first guide groove (e.g., the first guide groove 2411 of FIG. 6), a connecting groove (e.g., the connecting groove 2412 of FIG. 6), or a second guide groove 2413a (e.g., the second guide groove 2413 of FIG. 6).

According to an embodiment, the second guide groove 2413a may extend in a horizonal direction (e.g., the x direction) from the connecting groove 2412. In an embodiment, the second guide groove 2413a may form a second straight section that is a path along which the first fastening pin 290a inserted into the first fastening groove 241 moves. In an embodiment, the second guide groove 2413a may be recessed from one side surface of the pair of first lugs 240a so that the depth of the groove gradually increases toward the second direction. In an embodiment, the second guide groove 2413a may be recessed from one side surface of the pair of first lugs 240a so that the recess surface is formed to be inclined with respect to the second direction (e.g., the x direction).

In the process in which the first fastening pin 290a moves from the end of the second guide groove 2413a to the connecting groove 2412, the movement of the first fastening pin 290a is limited by the resistance generated when the first fastening pin 290a comes into contact with the recessed surface of the second guide groove 2413a processed to be inclined. Therefore, even when the first strap 250 does not come into contact with one side surface of the housing 210, easy separation of the first strap 250 from the pair of first lugs 240a may be reduced unless a separate external force is applied to the first strap 250.

According to an embodiment, an electronic device 200 may include a housing 210 having a pair of lugs 240a and 240b, whose inner surfaces face each other, provided on two opposite sides to be substantially symmetrical. The electronic device 200 may include a strap 250 or 260 configured to be fitted to the pair of lugs 240a and 240b provided in the housing 210 to be mounted or detachable. The electronic device 200 may include a fastening groove 241 connecting an open end 241a and a closed end 241b to have at least one bend is formed to face the inner surfaces of each of the pair of lugs 240a and 240b. In the electronic device 200, a fastening pin 290a or 290b may be provided near one end of the strap 250 or 260 to move along the fastening groove 241 when the strap 250 or 260 is mounted to or detached from the pair of lugs 240a and 240b. Here, one end portion 250a of the strap 250 or 260 provided with the fastening pin 290a or 290b may correspond to an end facing the housing when mounted to the housing, of two opposite ends provided in the strap 250 or 260.

According to an embodiment, the fastening pin 290a or 290b may have a structure having elasticity against pressing in two opposite directions.

According to an embodiment, in the electronic device 200, a pressing portion 256 may be formed that has an opening formed in a side surface facing the housing 210 when mounted to the housing 210 at one end 250a of the strap 250 or 260 provided with the fastening pin 290a or 290b.

According to an embodiment, in the electronic device 200, a hardness of an upper portion 257 of the opening may be configured to be different from a hardness of a lower portion 258 in the pressing portion 256 so that the opening is deformed by a pressure applied to an upper end of the strap 250 or 260 mounted to the housing.

According to an embodiment, in the electronic device 200, the hardness of an upper portion 257 of the opening may be configured to be relatively small as compared to the hardness of a lower portion 258.

According to an embodiment, in the electronic device 200, a thickness of an upper portion 257 of the opening may be configured to be different from a thickness of a lower portion 258 in the pressing portion so that the opening is deformed by a pressure applied to an upper end of the strap 250 or 260 mounted to the housing.

According to an embodiment, in the electronic device 200, the thickness of an upper portion 257 of the opening may be configured to be relatively thin as compared to the thickness of a lower portion 258.

According to an embodiment, the fastening groove 241 may include a first pin hole 2414 configured so that the fastening pin 290a or 290b is seated on the closed end 241b.

According to an embodiment, the fastening groove 241 may be configured to have a relatively shallow depth near the at least one bend as compared to the open end 241a.

According to an embodiment, the fastening groove 241 may be configured to have a relatively deep depth of the closed end 241b as compared with near the at least one bend.

According to an embodiment, in a fastening device fastening a straps 250 or 260 in an electronic device 200, a fastening groove 241 may be formed in inner surfaces of lugs 240a, 240b provided to face each other on two opposite sides of a housing 210 to connect an open end 241a and a closed end 241b to have at least one bend. In the fastening device, a fastening pin 290a or 290b or a pressing portion 256 may be provided near a first end 250a of the strap 250 or 260 to move along the fastening groove 241 when the strap 250 or 260 is mounted to or detached from the lugs 240a, 240b. Here, the first end 250a of the strap 250 or 260 provided with the pressing portion 256 or the fastening pin 290a or 290b may correspond to an end facing the housing when mounted to the housing, of two opposite ends provided in the strap 250 or 260.

According to an embodiment, the fastening pin 290a or 290b may have a structure having elasticity against pressing in two opposite directions.

According to an embodiment, the pressing portion 256 may include an opening formed in a side surface of the first end 250a facing the housing when mounted to the housing.

According to an embodiment, in the fastening device, a hardness of an upper portion 257 of the opening may be configured to be different from a hardness of a lower portion 258 in the pressing portion 256 so that the opening is deformed by a pressure applied to an upper end of the strap 250 or 260 mounted to the housing.

According to an embodiment, in the fastening device, the hardness of an upper portion 257 of the opening may be configured to be relatively small as compared to the hardness of a lower portion 258.

According to an embodiment, in the fastening device, a thickness of an upper portion 257 of the opening may be configured to be different from a thickness of a lower portion 258 in the pressing portion so that the opening is deformed by a pressure applied to an upper end of the strap 250 or 260 mounted to the housing.

According to an embodiment, in the fastening device, the thickness of an upper portion 257 of the opening may be configured to be relatively thin as compared to the thickness of a lower portion 258.

According to an embodiment, the fastening groove 241 may include a first pin hole 2414 configured so that the fastening pin 290a or 290b is seated on the closed end 241b.

According to an embodiment, the fastening groove 241 may be configured to have a relatively shallow depth near the at least one bend as compared to the open end 241a.

According to an embodiment, the fastening groove 241 may be configured to have a relatively deep depth of the closed end 241b as compared with near the at least one bend.

According to an embodiment, an electronic device 200 may include a housing 210 having a pair of lugs 240a and 240b, whose inner surfaces face each other, provided on two opposite sides to be substantially symmetrical. The electronic device 200 may include a strap 250 or 260 configured to be fitted to the pair of lugs 240a and 240b provided in the housing 210 to be mounted or detachable. The electronic device 200 may include a fastening groove 241 connecting an open end 241a and a closed end 241b to have at least one bend is formed to face the inner surfaces of each of the pair of lugs 240a and 240b. The electronic device 200 may include a fastening pin 290a or 290b provided near one end of the strap 250 or 260 to move along the fastening groove 241 when the strap 250 or 260 is mounted to or detached from the pair of lugs 240a and 240b. The electronic device 200 may include a pressing portion 256 having an opening formed in a side surface facing the housing 210 when mounted to the housing 210, and formed at one end 250a of the strap 250 or 260 provided with the fastening pin 290a or 290b. Here, one end portion 250a of the strap 250 or 260 provided with the fastening pin 290a or 290b may correspond to an end facing the housing when mounted to the housing, of two opposite ends provided in the strap 250 or 260.

According to an embodiment, the fastening groove 241 may have a non-constant depth.

According to an embodiment, the fastening groove 241 may include a depth that decreases from the open end 241a to the at least one bend and that increases from the at least one bend to the closed end 241b.

According to an embodiment, a hardness of an upper portion of the opening is configured to be relatively small as compared to a hardness of a lower portion of the opening so that the opening is deformed by a pressure applied to an upper end of the strap 250 or 260 mounted to the housing.

According to an embodiment, the fastening pin 290a or 290b may have a structure having elasticity against pressing in two opposite directions.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device, comprising:
a housing having a pair of lugs, whose inner surfaces face each other, provided on two opposite sides to be substantially symmetrical; and
a strap configured to be fitted to the pair of lugs provided in the housing to be mounted or detachable,
wherein a fastening groove connecting an open end and a closed end to have at least one bend is formed to face the inner surfaces of each of the pair of lugs,
wherein a fastening pin is provided near one end of the strap to move along the fastening groove when the strap is mounted to or detached from the pair of lugs, and
wherein one end portion of the strap provided with the fastening pin corresponds to an end facing the housing when mounted to the housing, of two opposite ends provided on the strap.

2. The electronic device of claim 1, wherein the fastening pin has a structure having elasticity against pressing in two opposite directions.

3. The electronic device of claim 1, the electronic device comprising:
wherein a pressing portion having an opening formed in a side surface facing the housing when mounted to the housing, and formed at one end of the strap provided with the fastening pin.

4. The electronic device of claim 3, wherein a hardness of an upper portion of the opening is configured to be relatively small as compared to a hardness of a lower portion of the opening so that the opening is deformed by a pressure applied to an upper end of the strap mounted to the housing.

5. The electronic device of claim 3, wherein a thickness of an upper portion of the opening is configured to be less than a thickness of a lower portion of the opening so that the opening is deformed by a pressure applied to an upper end of the strap mounted to the housing.

6. The electronic device of claim 1, wherein the fastening groove includes a pin hole configured so that the fastening pin is seated on the closed end.

7. The electronic device of claim 1, wherein the fastening groove is configured to have a depth near the at least one bend that is less than a depth at the open end.

8. The electronic device of claim 1, wherein the fastening groove is configured to have a depth of the closed end that is greater than a depth near the at least one bend.

9. A fastening device for fastening a strap in an electronic device,
wherein a fastening groove is formed in inner surfaces of lugs provided to face each other on two opposite sides of a housing to connect an open end and a closed end to have at least one bend,
wherein a fastening pin or a pressing portion is provided near a first end of the strap to move along the fastening groove when the strap is mounted to or detached from the lugs, and
wherein the first end of the strap provided with the pressing portion or the fastening pin corresponds to an end facing the housing when mounted to the housing, of two opposite ends provided in the strap.

10. The fastening device of claim 9, wherein the fastening pin has a structure having elasticity against pressing in two opposite directions.

11. The fastening device of claim 9, wherein the pressing portion includes an opening formed in a side surface of the first end facing the housing when mounted to the housing.

12. The fastening device of claim 11, wherein a hardness of an upper portion of the opening is less than a hardness of a lower portion of the opening so that the opening is deformed by a pressure applied to an upper end of the strap mounted to the housing.

13. The fastening device of claim 11, wherein a thickness of an upper portion of the opening is have a thickness that is less than a thickness of a lower portion of the opening so that the opening is deformed by a pressure applied to an upper end of the strap mounted to the housing.

14. The fastening device of claim 9, wherein the fastening groove includes a pin hole configured so that the fastening pin is seated on the closed end.

15. The fastening device of claim 9, wherein the fastening groove is configured to have a first depth near the at least one bend that is less than a second depth at the open end and to have a third depth at the closed end that is greater than the second depth.

16. An electronic device, comprising:
a housing having a pair of lugs, whose inner surfaces face each other, provided on two opposite sides to be substantially symmetrical;
a strap configured to be fitted to the pair of lugs provided in the housing to be mounted or detachable;
a fastening groove connecting an open end and a closed end to have at least one bend, formed to face the inner surfaces of each of the pair of lugs;
a fastening pin provided near one end of the strap to move along the fastening groove when the strap is mounted to or detached from the pair of lugs;
a pressing portion having an opening formed in a side surface facing the housing when mounted to the housing, and formed at one end of the strap provided with the fastening pin;
wherein one end portion of the strap provided with the fastening pin corresponds to an end facing the housing when mounted to the housing, of two opposite ends provided on the strap.

17. The electronic device of claim 16, wherein the fastening groove has a non-constant depth.

18. The electronic device of claim 16, wherein the fastening groove includes a depth that decreases from the open end to the at least one bend and that increases from the at least one bend to the closed end.

19. The electronic device of claim 16, wherein a hardness of an upper portion of the opening is configured to be relatively small as compared to a hardness of a lower portion of the opening so that the opening is deformed by a pressure applied to an upper end of the strap mounted to the housing.

20. The electronic device of claim 16, wherein the fastening pin has a structure having elasticity against pressing in two opposite directions.
